(19) United States
(12) Patent Application Publication
(10) Pub. No.: US 2014/0315063 A1
(43) Pub. Date: Oct. 23, 2014

(54) Automotive thermal ballast battery

(71) Applicant: Edward Milton McWhorter, Citrus Heights, CA (US)

(72) Inventor: Edward Milton McWhorter, Citrus Heights, CA (US)

(21) Appl. No.: 13/986,352

(22) Filed: Apr. 22, 2013

(51) Int. Cl. H01M 10/50

(52) U.S. Cl. CPC H01M 10/5073
USPC 429/120

(57) ABSTRACT

The invention is a large secondary cell. A fluid conduit passes through the cell. A fluid mass flowing within the conduit is used as a heat transfer medium in a vehicle battery pack to slow the temperature rise rate of the battery pack cathodes.

### CLAIM OF PRIORITY

The present application claims priority from U.S. application Ser. No. 12/802,436 filed Jun. 8, 2010 Publication US 2011-0300429-A1 Publication date Dec. 8, 2011 the content of which is hereby amended and incorporated by reference into this application.

### CROSS REFERENCES

Ref. 1 US 2010/020750 A1

Ref. 2 U.S. Pat. No. 6,831,825 B1

Ref. 3 U.S. Pat. No. 2,490,598

Ref. 4 US 2009/0142655 A1

Ref. 5 US 2010/0330460 A1

Ref. 6 U.S. Pat. No. 2,490,598 A Norris Olive George Francis

### BACKGROUND

The invention is a nickel-iron storage battery hereinafter called a ballast battery. The ballast battery is a large single voltaic cell having a plurality of cathodes connected in series and a plurality of anodes also electrically connected in series such that the assembled battery internal circuit forms a 1.8V single cell.

A fluid conduit passes through the ballast battery. The fluid mass flowing within the conduit is used as a heat transfer medium in an electrical vehicle battery pack to slow the temperature rise rate of the battery cathodes during charging. The manner in which the ballast battery is to be interconnected to an electrical vehicle battery pack is described in Ref. 1.

The fluidic heat transfer medium flowing in the battery conduit is positively charged exhaust emission from a fuel cell Ref. 2. Heat is generated when electrons collide with atoms in a metal. In a vehicle battery pack the critical limiting temperature is localized at the interface contact of the metal surface of the cathode with the electrolyte charging electrons. The importance of this critical thermal condition is ameliorated when the generated heat in this area is carried away by the heat transfer fluid of the ballast battery conduit and the reduction of cathode negative charge is reduced by reaction with the positive charged ionic flow in the said conduit. The amount of heat (Q) developed at the cathode metal interface with battery electrolyte, measured in calories, is determined from Ohms law (V=IR) by the relationship of Joules law (I²R) and is generally expressed as the mechanical equivalent of heat which is calculated as a function of charging rate current flow (I) and vehicle battery pack internal electrical resistance (R).

Q=0.24I²R

### SUMMARY OF THE INVENTION

The “Automotive Thermal Ballast Battery” provides a means of balancing the heat input into the cathode of a storage battery during charging. Allowing the battery to be charged at a faster rate.

### BRIEF DESCRIPTION OF THE DRAWINGS

A single drawing is presented. All of the elements which constitute the claimed novelty are presented in this drawing

FIG. 1 is drawn in accordance with the criteria of 35 USC 103 relative to how the battery is made limiting the recitation of constructive elements shown in side view section.

FIG. 1 is a section side view of the Ballast Battery assembly. All of the elements which constitute the claimed novelty are presented in this drawing.

### DETAILED DESCRIPTION OF THE INVENTION

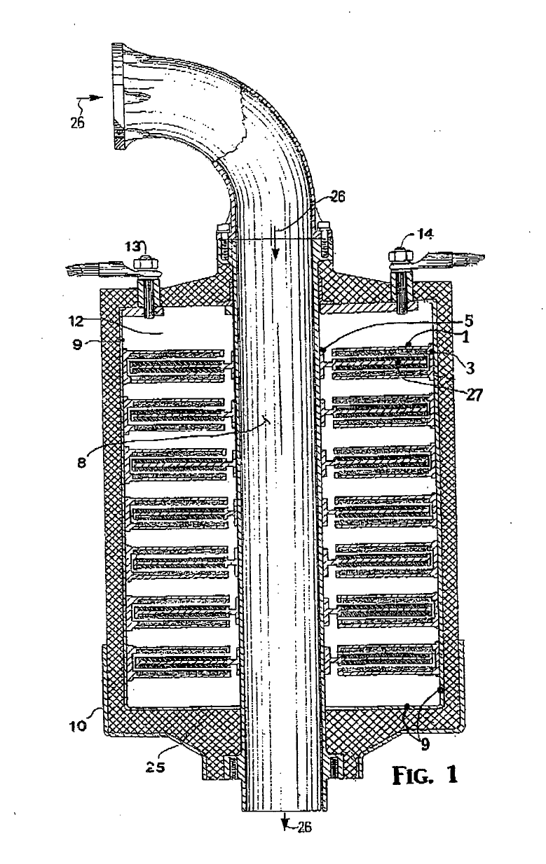

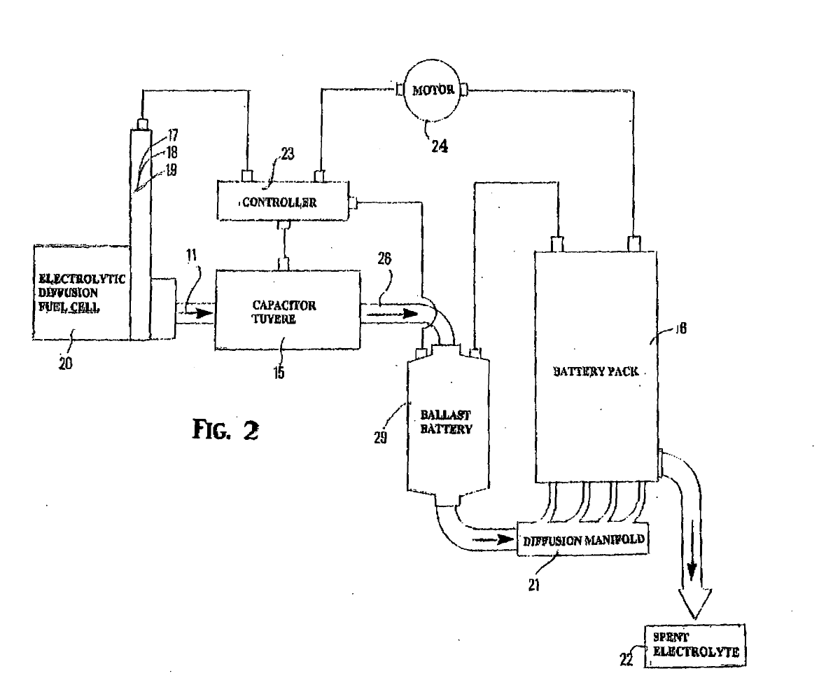

FIG. 1 is a section view of the assembled Ballast Battery showing a plurality of anode disc plates 1 (shown at 7 places) fixedly attached to the inner surfaces of the steel containment cylinder 9 by flanges 3. Positioned between each pair of said anode disc plates 1 is cathode disc plate 27 fixedly attached to fluid conduit 8 by flange 5. Seven paired anode disc plates 1 and seven cathode plates 5 are shown. The said seven cathode plates 27 attached to fluid conduit 8 and are prevented from contacting anode disc plates 1 by rubber separators and bushings not shown. A thick wall structure of asphalt extended rubber encasement 25 similar to that used in lead-acid storage batteries is shown in double cross-hatch reinforcing and electrically insulating steel outer structure 10 of the Ballast Battery to isolate the vehicle from spurious eddy currents. Positive charged gaseous diffusion flow 26 from an electrolytic diffusion fuel cell enters fluid conduit 8 passing through said conduit 8 and exits conduit 8. The anode and cathode disc plates 1 and 5 respectively are submerged in a 21% KOH electrolyte 12. The anode pole fastener 13 and cathode pole fastener 14 are positioned on the top surfaces of the Ballast Battery each shown as fixedly attached to the containment cylinder 9 and fluid conduit 8 respectively. The voltage between anode pole 13 and cathode pole 14 is 1.8V. This low voltage provides a convenient means of absorbing stray eddy currents from the metal masses of the capacitor tuyere and the diffusion fuel cell.

LIST OF ELEMENTS

```
  1. anode disc plate
  2.
  3. flange
  4.
  5. cathode disc plate
  6.
  7.
  8. fluid conduit
  9. containment cylinder
10. outer structure
11.
12. Electrolyte
13. anode pole
14. cathode pole
15. capacity tuyere
16. battery pack
17. nodular electrolytic fuel
18. alkaline electrode tape
19. fuel magazine
20. electrolytic diffusion fuel cell
21. diffusion gas manifold
22. spent electrolyte tank
23. controller
24. motor
25. rubber encasement
26. charged gaseous diffusion flow
27. Cathode disc plate
```

What is claimed is:

1-5. (canceled)

6. A single voltaic cell comprising a plurality of cathodes connected in parallel, forming the internal electrode circuit of the single voltaic cell positioned within steel containment cylinder, the cathode disc plates and the anode disc plates having holes through their centers for passage of a positive charged gaseous diffusion flow from an electrolytic fuel cell through a fluid conduit, the cathodes fixedly attached at evenly spaced positions on the fluid conduit, the anodes are evenly spaced on each side of the cathodes and fixedly attached to the steel containment cylinder, the cathode and anode are immersed in an electrolyte, electrical passing to a cathode pole an electrical lead passing to an anode pole.
